(19) United States
(12) Patent Application Publication
(10) Pub. No.: US 2020/0398985 A1
(43) Pub. Date: Dec. 24, 2020

(54) DETACHABLE DRONE GUIDE FOR VEHICLE

(71) Applicant: HONDA MOTOR CO., LTD., Tokyo (JP)

(72) Inventor: Ricky Jukuei HSU, Rancho Palos Verdes, CA (US)

(21) Appl. No.: 16/447,894

(22) Filed: Jun. 20, 2019

(51) Int. Cl. B64C 39/02; B64C 37/02; G08G 5/00

(52) U.S. Cl. CPC B64C 39/024; B64C 2201/141; G08G 5/0013; B64C 37/02

(57) ABSTRACT

The disclosure provides detachable aerial unmanned vehicle (UAV) drone for a vehicle. The drone may include one or more sensors configured to scan terrain surrounding the vehicle. The vehicle may include a navigation display configured to display a topographical map generated the UAV drone. The vehicle may receive via the navigation display, an indication of a location for the UAV and transmit, to the UAV, a command including the location. The UAV drone may scan, via one or more sensors located on the detachable drone, terrain surrounding the vehicle. The UAV drone may generate a topographical map based on the scanned terrain. The UAV drone and/or the vehicle may determine a navigable route for the vehicle based on the topographical map.

### TECHNICAL FIELD

The subject matter disclosed herein relates to an aerial drone and, more particularly, to an aerial drone that may be deployed from another vehicle.

### BACKGROUND

Sports utility vehicles (SUVs) are a popular consumer vehicle type due to their large passenger and cargo carrying abilities. Originally designed for off-road driving, SUVs have become common for family travel. Modern SUVs are still capable of off-road driving, and further improvements to suspensions and drive trains may increase off-road abilities.

Families may be interested in using an SUV or other vehicle for off-road driving. For example, a family may want to explore an outdoor area with children for educational purposes. Some SUV owners, however, may lack experience, knowledge, and skills for off-road driving. In particular, navigation difficulties and impediments to driving may present concerns for off-road driving.

In view of the foregoing, assistance for a vehicle operating in an off-road environment would be desirable. Further advantages will become apparent from the disclosure provided below.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In an aspect, the disclosure provides an a detachable drone for a vehicle. The drone may include one or more sensors configured to scan terrain surrounding the vehicle. The drone may include a memory and at least one processor communicatively coupled to the memory. The processor may be configured to scan, via the one or more sensors, terrain surrounding the vehicle. The processor may be configured to generate a topographical map based on the scanned terrain. The processor may be configured to determine a navigable route for the vehicle based on the topographical map.

In another aspect, the disclosure provides a method of operating a detachable drone for a vehicle. The method may include scanning, via one or more sensors located on the detachable drone, terrain surrounding the vehicle. The method may include generating a topographical map based on the scanned terrain. The method may include determining a navigable route for the vehicle based on the topographical map.

In another aspect, the disclosure provides a drone assisted vehicle. The drone assisted vehicle may include a navigation display configured to display a topographical map generated by an unmanned aerial vehicle (UAV) associated with the drone assisted vehicle. The drone assisted vehicle may include a memory and at least one processor communicatively coupled to the memory. The processor may be configured to receive, via the navigation display, an indication of a location for the UAV. The processor may be configured to transmit, to the UAV, a command including the location. The processor may be configured to receive from the UAV, topographical map data for the location.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

FIG. 1 illustrates an example driving scenario for a UAV drone to assist a vehicle, in accordance with an aspect of the disclosure;

FIG. 2 illustrates a second example driving scenario for a UAV drone to assist a vehicle with a road condition, in accordance with an aspect of the disclosure;

FIG. 3 illustrates a schematic diagram of an example UAV drone and components thereof, in accordance with an aspect of the disclosure;

FIG. 4 illustrates a side view of the example UAV drone of FIG. 3.

FIG. 5 illustrates a perspective view of the example UAV drone of FIG. 3 in a docked configuration;

FIG. 6 illustrates a schematic diagram of an example vehicle and components thereof, in accordance with an aspect of the disclosure;

FIG. 7 is a flowchart of an example method of controlling a UAV drone and vehicle in accordance with aspects of the present disclosure;

FIG. 8 presents an exemplary system diagram of various hardware components and other features for use in accordance with aspects of the present disclosure; and

FIG. 9 is a block diagram of various exemplary system components for use in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols, such as Controller Area network (CAN), Local Interconnect Network (LIN), among others.

A “memory,” as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

An “operable connection,” as used herein may include a connection by which entities are “operably connected”, is one in which signals, physical communications, and/or logical communications may be sent and/or received. An operable connection may include a physical interface, a data interface and/or an electrical interface.

A “vehicle,” as used herein, refers to any moving vehicle that is powered by any form of energy. A vehicle may carry human occupants or cargo. The term “vehicle” includes, but is not limited to: cars, trucks, vans, minivans, SUVs, motorcycles, scooters, boats, personal watercraft, and aircraft. In some cases, a motor vehicle includes one or more engines.

The term “graphical user interface,” “GUI,” or “user interface,” as used herein, can refer to a type of interface that allows users to interact with electronic devices, the vehicle system, the vehicle, vehicle applications or the like, through graphical icons, visual indicators such as secondary notation, text-based, type command labels, text navigation, and the like.

The term “screen,” “display screen,” or “display,” as used herein, can refer to a surface area upon which text, graphics and video are temporarily made to appear for human viewing. These may include, but are not limited to, eidophor, electroluminescent display (“ELD”), electronic paper, e-Ink, gyricon, light emitting diode display (“LED”), cathode ray tube (“CRT”), liquid-crystal display (“LCD”), plasma display panel (“PDP”), digital light processing (“DLP”), and the like.

In an aspect, the present disclosure provides a detachable drone that provides assistance to a driver of a vehicle as well as entertainment and education for passengers of the vehicle. The detachable drone may be an unmanned aerial vehicle (UAV) that may be attached to the vehicle. For example, the detachable drone may be positioned in a mounting location at the front of the vehicle that allows the sensors of the detachable drone guide to be operated while attached to the vehicle.

For driver assistance, the detachable drone provides route planning assistance and adaptive control of the vehicle. The detachable drone may operate from either the vehicle mounted position or remote flying location to provide navigation and route planning. For example, the detachable drone may fly up to obtain an elevated view and use depth sensors (e.g., LIDAR) to map terrain. An artificial intelligence system onboard either the drone or the vehicle may determine a navigable route for the vehicle based on the terrain mapping. Additionally, the drone may provide more detailed information about a route that may be used to adapt vehicle systems. For example, the drone may provide details of a route surface that are used to control a dynamic suspension system or dynamic tires.

A driver user interface may include a topographical map generated by one or more deployable drones. The contour map may also indicate the location of the deployable drones. The driver may control the drones, for example, by touching and dragging the representation of a drone to a different location on the contour map.

A drone may also provide a video feed to the driver and/or passengers. The drone may utilize artificial intelligence (implemented at the drone or on the vehicle) to identify objects of interest. For example, objects of interest may be identified objects (e.g., animals, trees, etc.) that match a theme of a trip.

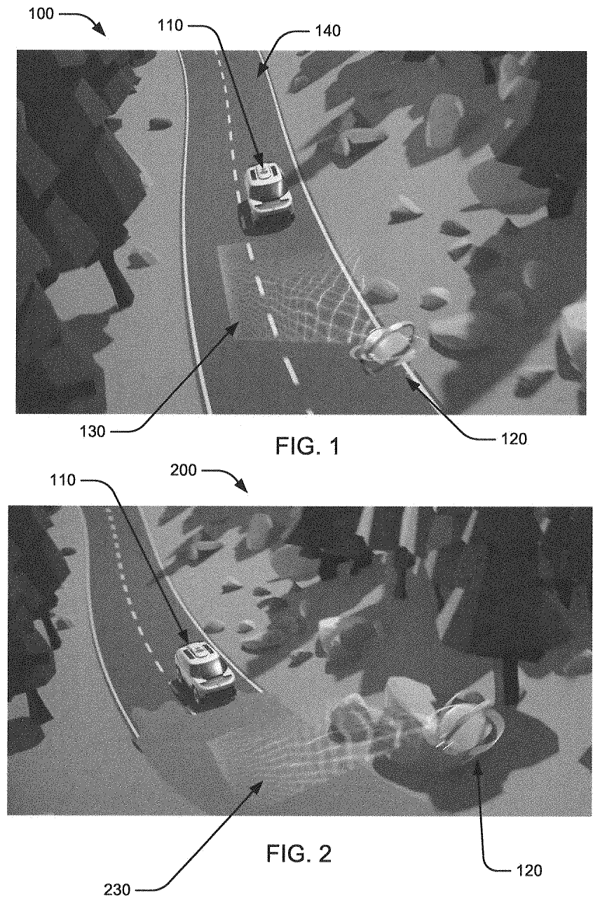

Turning to FIG. 1, an example operating environment 100 of a vehicle 110 and drone 120 may include a road 140. The drone 120 may fly ahead of the vehicle 110 and scan an area 130 surrounding the vehicle 110. For example, if the vehicle 110 is following a route along the road 140, the drone 120 may scan the area in front of the vehicle 110 for obstacles. In an aspect, the drone 120 may identify features of the route that may affect performance of the vehicle 110.

For example, turning to FIG. 2, the drone 120 may scan an area 230 that is covered with mud, water, debris, or another impediment. The drone 120 and/or the vehicle 110 may identify the impediment to the vehicle 110. In an aspect, the vehicle 110 may adapt a characteristic of a suspension or drive train of the vehicle 110 based on the detected impediment. For example, the vehicle 110 may reduce a speed in anticipating of the impediment. In another example, the vehicle 110 may include an electronically controllable suspension element such as a shock absorber. The vehicle 110 may harden or soften the suspension based on the impediment. In another aspect, the vehicle 110 may include electronically controllable tires. For example, the tires may include an electro active polymer that changes characteristics when an electric current is applied. Accordingly, for example, a tread pattern may be activated to increase grip of the tires on a muddy surface.

Although the examples in FIG. 1 and FIG. 2 illustrate scenarios where the vehicle 110 is driving along a road, the drone 120 may also be utilized in off-road scenarios. For example, the drone 120 may scan areas surrounding the vehicle 110 to generate a topographical map of the area. The vehicle 110 and/or the drone 120 may determine a navigable route through the scanned area based on the topographical map.

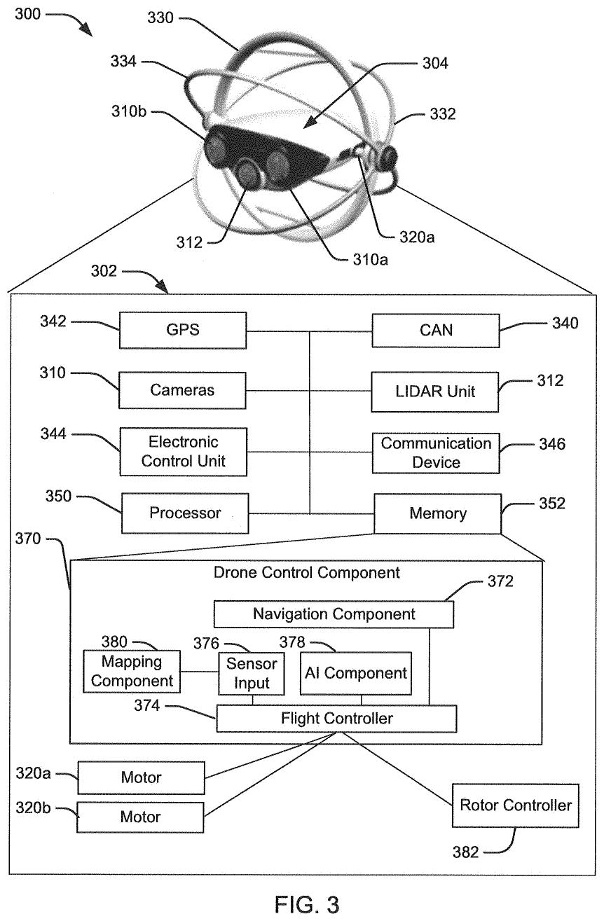

Turning to FIG. 3, an example drone 300 including a vehicle assistance system 302 is schematically illustrated. The drone 300 may be an example of the drone 120. The drone 120, however, may include different drone types, including currently available drones modified to include a vehicle assistance system 302, as described herein.

The drone 300 may include a body 304 that houses one or more sensors. For example, as illustrated, the sensors may include a left camera 310a, a right camera 310b, and a LIDAR unit 312. In an aspect, the sensors may be located on a front side of the body 304 and pointed in the same direction. The LIDAR unit 312 is may be a sensor that may be used for vehicular localization that emits light beams (e.g., laser beams) and may detect light beam reflections to determine the distance of objects in the environment. LIDAR may produce a point cloud of points representing distances to various objects in the environment. The left camera 310a and right camera 310b may be digital video cameras that generate video feed including consecutive frames. Because the left camera 310a and the right camera 310b are spaced apart, corresponding frames from each camera may be compared to determine a distance to an object

In use, the drone 300 may be positioned to scan an area using one or more of the sensors. The body 304 may also house components such as a power supply (not shown), a global positioning system (GPS) receiver 342, a controller area network (CAN) 340, an electronic control unit (ECU) 344, a communication device 346, a processor 350, and a memory 352.

In an aspect, the drone 300 may include a propulsion system including a plurality of concentric rotating rings 330, 332, 334. Each of the rings 330, 332, 334 may be a circular rotor. The rings 330, 332, 334 may rotate around the body 304 to generate lift and to steer the drone 300. For example, the rings 330, 332, 334 may change shape during a rotation based on the direction of movement such that the movement of the ring generates upward lift. The rings 330, 332, 334 may be driven by motors 320a and 320b, which may be positioned on opposite sides of the body 304. Each ring 330, 332, 334 may be driven by one of the motors 320a or 320b. In an aspect, a concentric drive shaft may be used to drive two rings from the same side using different motors. Accordingly, the rings 330, 332, 334 may be driven in the same direction or opposite directions. Additionally, the rings 330, 332, 334 may be driven at different speeds. In an aspect, turning and sideways movement of the drone 300 may be achieved via different rotational speeds of the rings. For example, an outermost ring 334 may generate thrust toward one side, and the middle ring 332 may generate thrust toward the opposite side. The inner ring 330 may generate upward thrust.

The vehicle assistance system 302 may reside within the drone 300. The components of the vehicle assistance system 302, as well as the components of other systems, hardware architectures, and software architectures discussed herein, may be combined, omitted or organized into various implementations.

The vehicle assistance system 302 may generally include an electronic control unit (ECU) 344 that operably controls a plurality of drone systems. The vehicle systems may include, but are not limited to a suspension control system, a steering control system, an acceleration control system, and the like. The vehicle assistance system 302 may also include a processor 350 and a memory 352 that communicate with the ECU 344, and controller area network (CAN) 340. The vehicle assistance system 302 may also include a communication device 346 that may provide wireless communication between the drone 300 and the vehicle 110.

The ECU 162 may include internal processing memory, an interface circuit, and bus lines for transferring data, sending commands, and communicating with the vehicle systems. The ECU 162 may include an internal processor and memory, not shown. The drone 300 may also include a bus for sending data internally among the various components of the vehicle assistance system 302.

The memory 352 may store instructions executable by the processor 350 for carrying out the methods described herein. Further, the memory 352 may store parameters for carrying out the methods described herein. For example, the memory 352 may store a drone control component 370, which may include software executable by the processor 350 for operating the vehicle assistance system 302.

The drone control component 370 may also include a navigation component 372 that determines a destination location. For example, the navigation component 372 may receive an indication of the destination location from the vehicle 110 via the communication device 346. In another aspect, the drone control component 370 may determine the destination location based on an area that needs to be scanned. For example, the destination location may be based on a route of the vehicle 110 and/or an unscanned area of a topographical map. The navigation component 372 may compare a current GPS location with the destination location and provide directional commands to a flight controller 374 to navigate the drone 300 to the destination location.

The drone control component 370 may include a sensor input 376 that receives input from the sensors including cameras 310 and LIDAR unit 312. The sensor input 376 may be used for object avoidance. For example, the sensor input 376 may determine whether any objects are blocking a travel path of the drone 300 as determined by the navigation component 372.

The drone control component 370 may include an artificial intelligence (AI) component 378. The AI component 378 may perform various analysis of the sensor input. For example, the AI component 378 may identify an object detected in a video feed. In an aspect, the AI component 378 may use a trained neural network to compare the object to known images. In another aspect, the AI component 378 may utilize a remote AI service. For example, the AI component 378 may upload a frame of the video feed including an object to a web service that returns an identification of the object. The web service may also provide additional information (e.g., educational materials) along with the identification of the object.

The drone control component 370 may include a mapping component 380 that generates a topographical map based on scanning performed by the sensors. The topographical map may include geographical locations associated with an elevation of each location. For example, the topographical map may be represented by contour curves having the same elevation. In an aspect, the topographical map may also include an identification of a surface. For example, the AI component 378 may identify surfaces such as pavement, dirt, mud, grass, or water based on images.

In an aspect, the flight controller 374 may generate motor control signals based on one or more of a sensor input 376, AI component 378, and navigation component 372. For example, the navigation component 372 may provide a directional command indicating a desired direction of travel. The sensor input 376 may identify any obstacles blocking a direct route in the desired direction of travel (e.g., by sensing an object within a threshold distance using the LIDAR unit 312). The AI component 378 may determine a route around an object, for example, by detecting edges of the object. The AI component 378 may set a new direction of travel until the drone 300 has cleared the detected object. The flight controller 374 may generate control signals to the motors 320 and the rotor controller 382 to generate an amount of thrust to move the drone 300 in the desired direction.

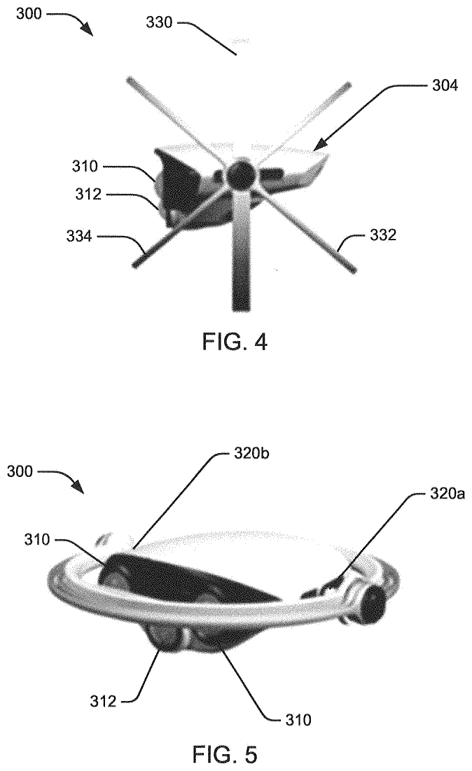

FIG. 4 illustrates a side view of the example drone 300. As illustrated, when the drone 300 is deployed, the rings 330, 332, 334 may be spaced apart. As the rings 330, 332, 334 rotate around the body 304, the rings 330, 332, 334 will pass in front of the sensors 310, 312. The sensors 310, 312 may be configured to obtain images between the rings 330, 332, 334. For example, the flight controller 374 may provide a gate signal indicating when one of the rings 330, 332, 334 is passing in front of the sensors 310, 312. Accordingly, the sensors 310, 312 may perform scanning when the gate signal is off.

FIG. 5 illustrates a perspective view of the drone 300 in a docked configuration. In the docked configuration, the rings 330, 332, 334 may be aligned. The rings 330, 332, 334 may engage a docking feature on the vehicle 110. The sensors 310, 312 may be oriented below the rings 330, 332, 334 such that the sensors 310, 312 have a clear view of the road while in the docked configuration.

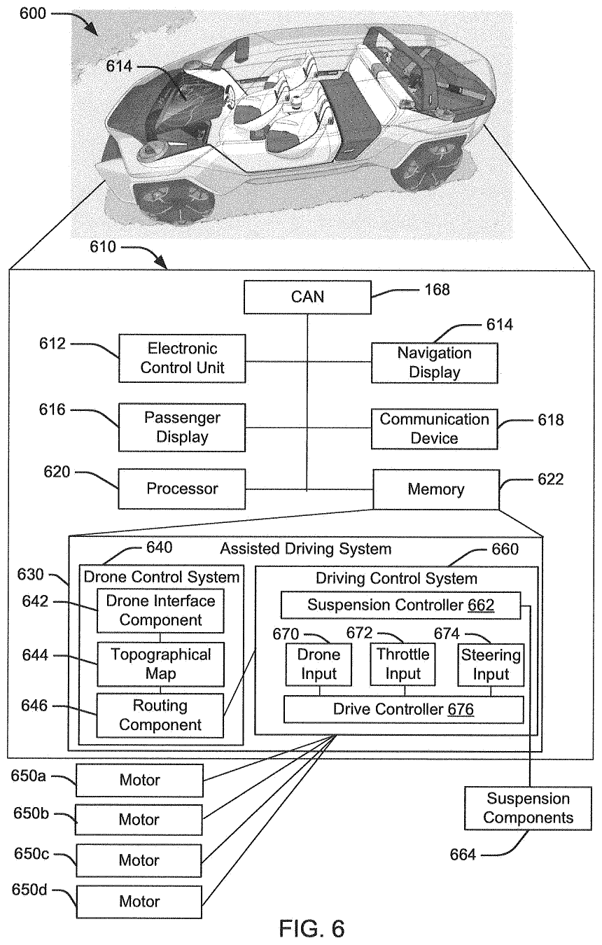

Turning to FIG. 6, a schematic view of an example operating environment of an example vehicle 600 includes an assisted driving system 630. The vehicle 600 may be an example of the vehicle 110. The assisted driving system 630 may reside within the vehicle 600 along with other components of a semi-autonomous driving system 610. The semi-autonomous driving system 610 may be considered a level 4 autonomous driving system that is capable of fully autonomous driving but also provides controls for a human driver to control the vehicle 600. The components of the semi-autonomous driving system 610, as well as the components of other systems, hardware architectures, and software architectures discussed herein, may be combined, omitted, or organized into various implementations.

The vehicle 600 may generally include an electronic control unit (ECU) 612 that operably controls a plurality of vehicle systems. The vehicle systems may include, but are not limited to the assisted driving system 630, among others, including a drone control system 640, a driving control system 660, a navigation display 614, vehicle HVAC systems, vehicle audio systems, vehicle video systems, vehicle infotainment systems, vehicle telephone systems, and the like.

Drone control system 640 may provide input to the drone 300 and receive driving assistance from the drone 300. In particular, the drone control system 640 may include a drone interface component 642 configured to communicate with the drone 300 via the communications device 618. In an aspect, the drone interface component 642 may provide a driver interface on a navigation display 614. For example, as illustrated, the navigation display 614 may be located in a position visible to the driver. The navigation display 614 may display a topographical map 644 generated by the drone 300. The drone interface component 642 may allow the driver to interact with the drone 300 via the topographical map 644. For example, the topographical map 644 may include an indication of a location of the vehicle 600 and the drone 300. The drone interface component 642 may receive, from the driver, an indication of a region remote from the vehicle. The drone interface component 642 may generate a command based on the indication to control the drone 300 to navigate to the indicated region. As another example, the drone interface component 642 may receive a selection of the indication of the drone 300 on the topographical map 644 and allow the driver to move the indication of the drone 300 to a different location. The drone interface component 642 may generate a command based on the change in location to control the drone 300 to navigate to the different location.

The drone control system 640 may also include a routing component 646 that may determine a navigable route based on the topographical map 644. The routing component 646 may be configured with rules regarding terrain and surfaces that the vehicle 600 is capable of crossing. For example, the vehicle 600 may be configured for basic off-road driving that allows the routing component 646 to plan a route that includes grass, dirt, and mud with limitations on elevation changes or gradients. A configuration for more advanced off-road driving may allow traversing streams. In an aspect, the routing component 646 may illustrate navigable regions on the topographical map 644 and allow the driver to select a navigable route, for example, by drawing a path through the navigable regions. The routing component 646 may provide the navigable route to the driving control system 660 for autonomous or assisted driving.

The driving control system 660 may provide control of one or more vehicle components based on the topographical map 644 and/or navigable route. The driving control system 660 may include a suspension controller 662. The vehicle 600 may include a dynamic suspension including suspension components 664. For example, the suspension components 664 may include an adjustable shock absorbers and/or adjustable tires. The suspension controller 662 may whether anticipated terrain determined according to the topographical map and navigable route indicate adjustments to the suspension. For example, bumpy terrain (e.g., with frequent elevation changes) may indicate extending the shock absorbers to increase vehicle clearance and softening the shock absorbers to dampen the bumps. As another example, muddy terrain may indicate activation of a tread pattern of the adjustable tires.

The driving control system 660 may also include a drive controller 676 that may generate motor control signals based on one or more of a drone input 180, a throttle input 182, and a steering input 184. The motor control signals may be provided to motors 650a, 650b, 650c, 650d associated with each wheel of the vehicle 600. For example, each wheel may be driven by a separate motor 650. In an aspect, the throttle input 182 may be based on driver input to the controls 114, for example, indicating a throttle level or value. Similarly, the steering input 184 may be a steering value based on driver input to the controls. The drone input 180 may be, for example, based on terrain or impediments identified by the drone 300. The drive controller 676 may, for example, reduce speed of the vehicle 600 when approaching bumpy or slippery terrain.

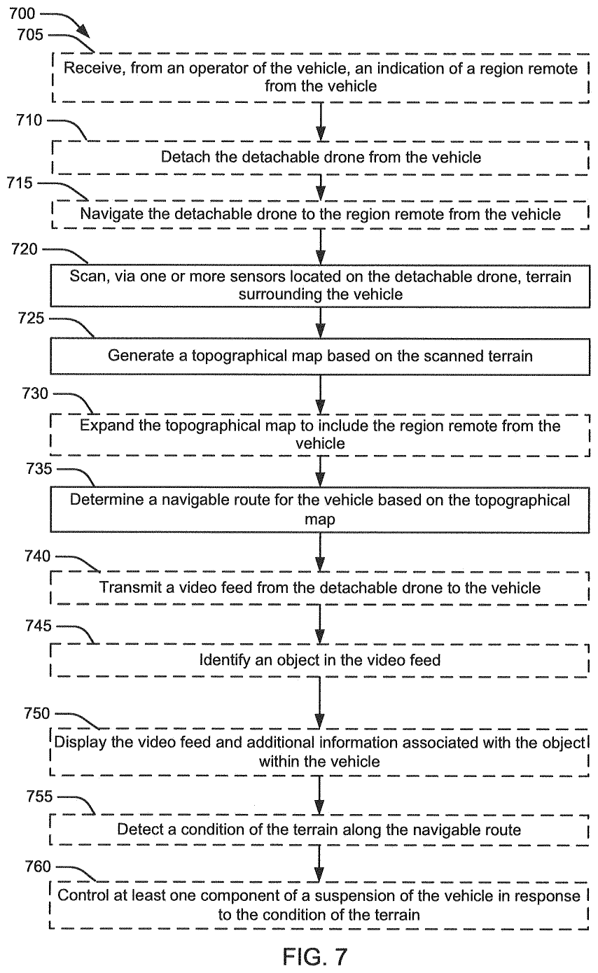

FIG. 7 illustrates a flowchart of an example method 700 for assisting vehicle navigation with a drone. The method 700 may be performed by a drone 300 including a vehicle assistance system 302 operating in communication with a vehicle 600 including an semi-autonomous driving system 610.

In block 705, the method 700 may optionally include receiving, from an operator of the vehicle, an indication of a region remote from the vehicle. In an aspect, for example, the navigation display 614 may receive, from the operator of the vehicle 600, an indication of a region remote from the vehicle. For example, the driver may touch or point to an area of the navigation display 614 that represents a region remote from the vehicle. For example, the region may be outside of a field of view of the drone 300 mounted on the vehicle 600. The region remote from the vehicle may be represented by a blank area on the topographical map 644 displayed on the navigation display 614. In an aspect, where the drone 300 is flying, the driver may move an indication of the location of the drone 300 on the topographical map 644 displayed on the navigation display 614 to a different location (e.g., a blank area representing a remote region).

In block 710, the method 700 may optionally include detaching the detachable drone from the vehicle. For example, the drone control component 370 may execute the flight controller 374 to detach the drone 300 from the vehicle 600. For example, the flight controller 374 may generate a control signal that causes the motors 320 to rotate the rings 330, 332, 334 into a flight configuration, thereby detaching the drone 300 from the vehicle 600.

In block 715, the method 700 may optionally include navigating the detachable drone to the region remote from the vehicle. In an aspect, for example, the drone control component 370 may execute the navigation component 372 to navigate the drone 300 to the region remote from the vehicle 600. That is, the navigation component 372 may determine a direction of travel to the region remote from the vehicle 600. The flight controller 374 may generate control signals to control the motors 320 and rotor controller 382 to fly the drone 300 to the region remote from the vehicle 600.

In block 720, the method 700 may include scanning, via one or more sensors located on the detachable drone, terrain surrounding the vehicle. In an aspect, for example, the drone control component 370 may scan, via the cameras 310 and/or LIDAR unit 312 located on the drone 300, terrain surrounding the vehicle 600 and/or terrain at the location remote from the vehicle 600.

In block 725, the method 700 may include generating a topographical map based on the scanned terrain. In an aspect, for example, the drone control component 370 may execute the mapping component 380 to generate the topographical map 644 based on the scanned terrain.

In block 730, the method 700 may optionally include expanding the topographical map to include the region remote from the vehicle. For example, where the drone 300 has navigated to the region remote from the vehicle, the drone control component 370 may execute the mapping component 380 to expand the topographical map to include the region remote from the vehicle.

In block 735, the method 700 may include determining a navigable route for the vehicle based on the topographical map. In an aspect, for example, the drone control component 370 may execute the mapping component 380 and/or the assisted driving system 630 may execute the routing component 646 to determine a navigable route for the vehicle 600 based on the topographical map 644. For example, determining the navigable route may include determining whether the vehicle 600 is able to or is allowed to traverse the terrain identified by the scanning in block 720. For instance, the routing component 646 may be configured with rules for the vehicle 600 that indicate whether terrain at a location is navigable. In an aspect, the routing component 646 may display areas of navigable terrain on the navigation display 614 and a driver may select a navigable route by drawing a line across the navigable terrain.

In block 740, the method 700 may optionally include transmitting a video feed from the detachable drone to the vehicle. In an aspect, for example, the vehicle assistance system 302 may control the cameras 310 and the communication device 356 to transmit a video feed from the cameras 310 to the vehicle 600.

In block 745, the method 700 may optionally include identifying an object in the video feed. In an aspect, for example, the drone control component 370 may control the AI component 378 to identify an object in the video feed. The AI component 378 may control the drone 300 via the flight controller 374 to maintain the object within the video feed. For example, the AI component 378 may cause the drone 300 to follow a moving object such as an animal. Accordingly, the drone 300 may continue to transmit the video feed including the object from the detachable drone to the vehicle 600.

In block 750, the method 700 may optionally include displaying the video feed and additional information associated with the object within the vehicle. In an aspect, for example, the assisted driving system 630 may control the passenger display 616 to displaying the video feed and additional information associated with the object within the vehicle. For example, the additional information associated with the object may include educational materials that may be downloaded based on the identified object.

In block 755, the method 700 may optionally include detecting a condition of the terrain along the navigable route. In an aspect, for example, the assisted driving system 630 may control the driving control system 660 to detect a condition of the terrain along the navigable route. For instance, the driving control system 660 may detect conditions based on the topographical map 644 provided by the drone 300. Accordingly, such conditions may be detected before a vehicle mounted sensor or human driver could detect such conditions, thereby providing the driving control system more time to react to the conditions.

In block 760, the method 700 may optionally include controlling at least one component of a suspension of the vehicle in response to the condition of the terrain. In an aspect, for example, the driving control system 660 may control the suspension controller 662 and/or the drive controller 676 to control at least one component of a suspension of the vehicle in response to the condition of the terrain.

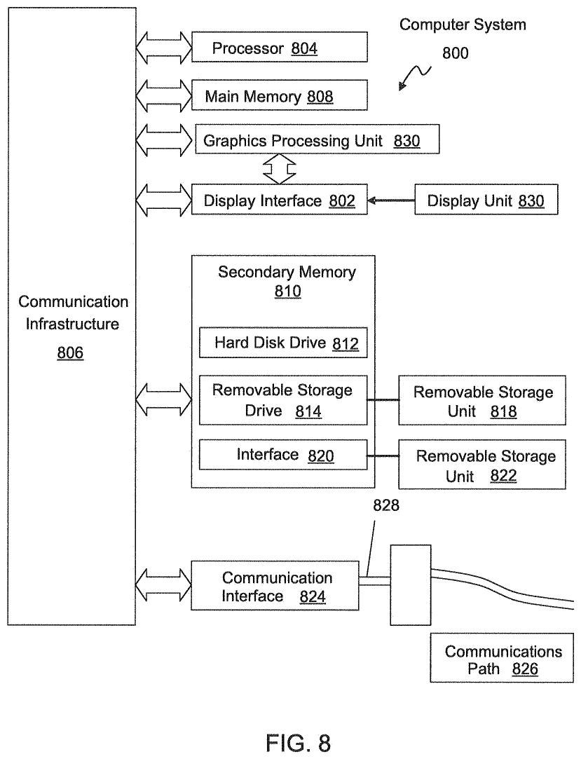

Aspects of the present disclosure may be implemented using hardware, software, or a combination thereof and may be implemented in one or more computer systems or other processing systems. In one aspect, the disclosure is directed toward one or more computer systems capable of carrying out the functionality described herein. For example, the computer system may implement the vehicle assistance system 302 and/or the semi-autonomous driving system 610. FIG. 8 presents an example system diagram of various hardware components and other features that may be used in accordance with aspects of the present disclosure. Aspects of the present disclosure may be implemented using hardware, software, or a combination thereof and may be implemented in one or more computer systems or other processing systems. In one exemplary variation, aspects of the disclosure are directed toward one or more computer systems capable of carrying out the functionality described herein. An example of such a computer system 800 is shown in FIG. 8.

Computer system 800 includes one or more processors, such as processor 804. The processor 804 is connected to a communication infrastructure 806 (e.g., a communications bus, cross-over bar, or network). Various software aspects are described in terms of this example computer system. After reading this description, it will become apparent to a person skilled in the relevant art(s) how to implement aspects of the disclosure using other computer systems and/or architectures.

Computer system 800 may include a display interface 802 that forwards graphics, text, and other data from the communication infrastructure 806 (or from a frame buffer not shown) for display on a display unit 830. In an aspect, the display unit 830 may correspond to the display device 169. Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a magnetic tape drive, an optical disk drive, etc. The removable storage drive 814 reads from and/or writes to a removable storage unit 818 in a well-known manner. Removable storage unit 818, represents a floppy disk, magnetic tape, optical disk, etc., which is read by and written to removable storage drive 814. As will be appreciated, the removable storage unit 818 includes a computer usable storage medium having stored therein computer software and/or data.

In alternative aspects, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket, and other removable storage units 822 and interfaces 820, which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824 are in the form of signals 828, which may be electronic, electromagnetic, optical or other signals capable of being received by communications interface 824. These signals 828 are provided to communications interface 824 via a communications path (e.g., channel) 826. This path 826 carries signals 828 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 880, a hard disk installed in hard disk drive 870, and signals 828. These computer program products provide software to the computer system 800. Aspects of the disclosure are directed to such computer program products.

Computer programs (also referred to as computer control logic) are stored in main memory 808 and/or secondary memory 810. Computer programs may also be received via communications interface 824. Such computer programs, when executed, enable the computer system 800 to perform various features in accordance with aspects of the present disclosure, as discussed herein. In particular, the computer programs, when executed, enable the processor 804 to perform such features. Accordingly, such computer programs represent controllers of the computer system 800.

In variations where aspects of the disclosure are implemented using software, the software may be stored in a computer program product and loaded into computer system 800 using removable storage drive 814, hard disk drive 812, or communications interface 820. The control logic (software), when executed by the processor 804, causes the processor 804 to perform the functions in accordance with aspects of the disclosure as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects of the disclosure are implemented using a combination of both hardware and software.

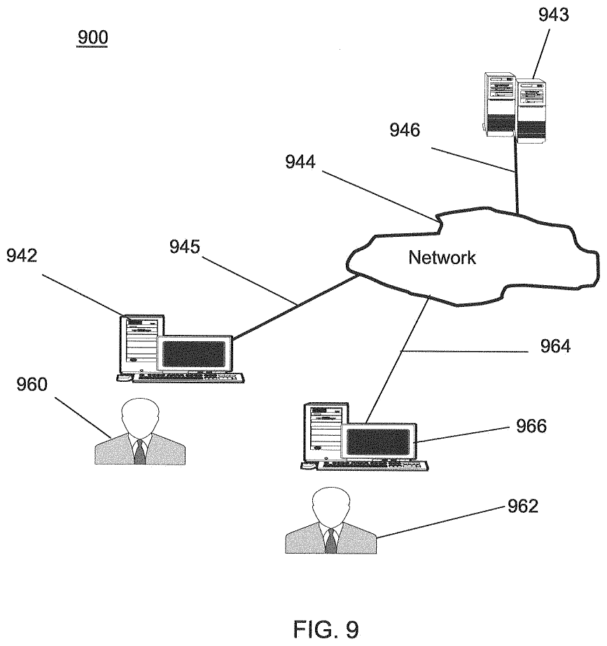

FIG. 9 is a block diagram of various example system components that may be used in accordance with aspects of the present disclosure. For example, the various components may be within the drone 300 or vehicle 600, or only some of the components may be within the drone 300 or vehicle 600, and other components may be remote from the drone 300 or vehicle 600. The system 900 includes one or more accessors 960, 962 (also referred to interchangeably herein as one or more “users”) and one or more terminals 942, 966 (such terminals may be or include, for example, various features of the control system 160). In one aspect, data for use in accordance with aspects of the present disclosure is, for example, input and/or accessed by accessors 960, 962 via terminals 942, 966, such as personal computers (PCs), minicomputers, mainframe computers, microcomputers, telephonic devices, or wireless devices, such as personal digital assistants (“PDAs”) or a hand-held wireless devices coupled to a server 943, such as a PC, minicomputer, mainframe computer, microcomputer, or other device having a processor and a repository for data and/or connection to a repository for data, via, for example, a network 944, such as the Internet or an intranet, and couplings 945, 946, 964. The couplings 945, 946, 964 include, for example, wired, wireless, or fiber optic links. In another example variation, the method and system in accordance with aspects of the present disclosure operate in a stand-alone environment, such as on a single terminal.

The aspects of the disclosure discussed herein may also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A detachable drone for a vehicle, comprising:
one or more sensors configured to scan terrain surrounding the vehicle;
a memory; and
at least one processor communicatively coupled to the memory, wherein the at least one processor is configured to:
scan, via the one or more sensors, terrain surrounding the vehicle;
generate a topographical map based on the scanned terrain; and
determine a navigable route for the vehicle based on the topographical map.

2. The detachable drone of claim 1, further comprising:
a body that houses the memory, the at least one processor, and the one or more sensors; and
a plurality of circular rotors that rotate around the body.

3. The detachable drone of claim 2, wherein the plurality of circular rotors are configured to rotate to an aligned position when the detachable drone is attached to the vehicle.

4. The detachable drone of claim 2, wherein the one or more sensors are configured to scan the terrain during an interval between consecutive rotors of the plurality of circular rotors obscuring a respective sensor.

5. The detachable drone of claim 2, wherein each of the plurality of circular rotors is configured to change shape during a rotation around the body.

6. The detachable drone or claim 2, further comprising a pair of motors positioned at opposite sides of the body, each motor coupled to one or more of the plurality of circular rotors.

7. The detachable drone of claim 1, wherein the one or more sensors includes a video camera configured to capture a video feed at a location of the detachable drone, wherein the at least one processor is configured to:
identify an object in the video feed;
maintain the object within the video feed; and
transmit the video feed including the object from the detachable drone to the vehicle.

8. A method of operating a detachable drone for a vehicle, comprising:
scanning, via one or more sensors located on the detachable drone, terrain surrounding the vehicle;
generating a topographical map based on the scanned terrain; and
determining a navigable route for the vehicle based on the topographical map.

9. The method of claim 8, further comprising:
receiving, from an operator of the vehicle, an indication of a region remote from the vehicle;
detaching the detachable drone from the vehicle; and
navigating the detachable drone to the region remote from the vehicle.

10. The method of claim 9, further comprising:
scanning, via the one or more sensors, the region remote from the vehicle; and
expanding the topographical map to include the region remote from the vehicle.

11. The method of claim 9, further comprising:
transmitting a video feed from the detachable drone to the vehicle.

12. The method of claim 11, further comprising:
identifying an object in the video feed; and
displaying the video feed and additional information associated with the object within the vehicle.

13. The method of claim 9, further comprising:
detecting a condition of the terrain along the navigable route; and
controlling at least one component of a suspension of the vehicle in response to the condition of the terrain.

14. The method of claim 13, further comprising displaying the topographical map on a driver interface, the topographical map including an indication of a location of the detachable drone.

15. The method of claim 14, wherein receiving the indication of the region remote from the vehicle comprises receiving a signal indicating that the operator has moved the indication of the location of the detachable drone on the driver interface.

16. A drone assisted vehicle comprising:
a navigation display configured to display a topographical map generated by an unmanned aerial vehicle (UAV) associated with the drone assisted vehicle;
a memory; and
at least one processor communicatively coupled to the memory, wherein the at least one processor is configured to:
receive, via the navigation display, an indication of a location for the UAV;
transmit, to the UAV, a command including the location; and
receive from the UAV, topographical map data for the location.

17. The drone assisted vehicle of claim 16, further comprising:
an adjustable suspension system, wherein the at least one processor is configured to control the adjustable suspension system based on the topographical map data.

18. The drone assisted vehicle of claim 16, further comprising a passenger display configured to display a video feed transmitted from the UAV.

19. The drone assisted vehicle of claim 18, wherein the at least one processor is further configured to identify an object within the video feed and display the video feed and additional information associated with the object on the passenger display.

20. The drone assisted vehicle of claim 18, wherein the at least one processor is configured to display a current location of the UAV on the topographical map and determine that an operator has moved the indication of the location of the UAV on the navigation display.
